(19) United States
(12) Patent Application Publication
(10) Pub. No.: US 2002/0144216 A1
(43) Pub. Date: Oct. 3, 2002

(54) Method for rapid, reusable system on a chip functional verification

(76) Inventors: Elizabeth A. Leonard, Sunnyvale, CA (US); Que-Won Rhee, Palo Alto, CA (US); Amy Bonsall, Sunnyvale, CA (US)

Correspondence Address: AGILENT TECHNOLOGIES, Legal Department, 51U-PD, Intellectual Property Administration, P.O. Box 58043, Santa Clara, CA, 95052-8043, US

(21) Appl. No.: 09/773,310

(22) Filed: Jan. 31, 2001

(51) Int. Cl. G06F 17/50

(52) U.S. Cl. 716/4; 716/5

(57) ABSTRACT

A simulation controller includes a global process manager that creates a model manager and a vector manager. The model manager generates models when requested by the global process manager. The vector manager generates vectors when requested by the global process manager. The global process manager manages the models and vectors to be received by a target simulator. This approach allows the verification plan associated with circuit block described in a hardware description language to be reused in a new circuit design.

### FIELD OF THE INVENTION

The invention relates to the field of circuit design, particularly towards circuit simulation and verification prior to production.

### BACKGROUND

The process of verifying that an electrical circuit is designed without functional mistakes is a difficult one. Dramatic increases in application specific integrated circuit (ASIC) capacity and decreasing design cycles times are forcing more efficient ASIC development cycles. To meet these demands, circuit designers seek to reuse circuit blocks, e.g. the hardware design description language implementation of the functional block, in new ASIC designs. Many seek to leverage older circuit block designs alongside new designs in different combinations. Several techniques have been used to verify that a design will perform as expected. These techniques include simulation, formal verification, assisted simulation, and reference models.

The circuit block, e.g. Verilog or VHDL, is simulated using a commercially available tool, e.g. Verilog XL by Cadence or Modelsim by MTI. The input stream, e.g. vectors, are generated by a circuit designer using the hardware description language (HDL). The outputs are waveforms in a standard format and screen messages. Despite the improved performance of the design tools, simulation time increases with the complexity of the circuit under test. Thus, it can be cumbersome to generate vectors.

Formal verification uses mathematics to prove that the logic functions as expected. The drawbacks to most formal verification are twofold. First, commercial tools cannot handle large circuit blocks. Second, it is non-intuitive to write formulas that correspond to the logic circuitry.

Several commercial tools, e.g. Vera from Synopsys or Specman from Verisity, provide assisted simulation. These tools are intermediary tools that exist as interfaces to the simulator. They primarily consist of a computer language for specifying input to the simulator and a debugging environment. While this path expeditiously generates structured simulation data, it does not structure the environment enough to guarantee that verification information can be transferred from circuit design to circuit design.

Another prior art technique is to use reference models. The reference models ideally behave the same way as the circuit design under test. These models aid in verification but are often very expensive.

As complexity of ASICs increase, it is desirable to maintain or reduce the time of the development cycle in a cost-effective manner.

### SUMMARY

When an application specific integrated circuit (ASIC) is designed, interactions between pre-existing circuit blocks must be tested as part of the verification effort. Often, these pre-existing circuit blocks are part of more than one ASIC. ASIC development time can be reduced by describing the pre-existing circuit blocks once in a hardware design language. When the circuit block is used in concert with another design, the block names for inputs and outputs must be mapped to the design names. Hence, for a new circuit design, often another HDL verification description must be generated for the pre-existing circuit block. This is a manual and labor-intensive effort.

The present invention enables reuse of the design and verification efforts for pre-existing circuit blocks from design to design. A simulation controller orchestrates a set of instructions in a computer language to be used on a target simulator. A structured test plan and environment description are user instructions provided to the simulation controller.

A simulation controller includes a global process manager that creates a model manager and a vector manager. The global process manager receives an environment parameter describing the target simulator, a user-defined circuit design e.g. “testbench”, vectors associated with the “testbench”, and list of pre-existing circuit blocks. The model manager generates models when requested by the global process manager. The vector manager generates vectors when requested by the global process manager. The global process manager manages the models and vectors to be received by a target simulator such that a test plan specific to the pre-existing circuit block and environment.

### BRIEF DESCRIPTION OF THE DRAWINGS

FIG. 1 illustrates a simulation controller of the present invention.

FIG. 2 illustrates the inheritance concept used in the present invention.

FIG. 3 illustrates the base class VObject.

FIG. 4 illustrates the inheritance from VObject.

FIG. 5 illustrates how the ModelManager interacts with other models.

FIG. 6 illustrates the phases managed by the ModelManager.

### DETAILED DESCRIPTION OF THE DRAWINGS

When an application specific integrated circuit (ASIC) is designed, interactions between pre-existing circuit blocks must be tested as part of the verification effort. Often, these pre-existing circuit blocks are part of more than one ASIC. ASIC development time can be reduced by describing the pre-existing circuit blocks once in a hardware design language. When the circuit block is used in concert with another design, the block names for inputs and outputs must be mapped to the design names. Hence, for a new circuit design, often another HDL verification description must be generated for the pre-existing circuit block. This is a manual and labor-intensive effort.

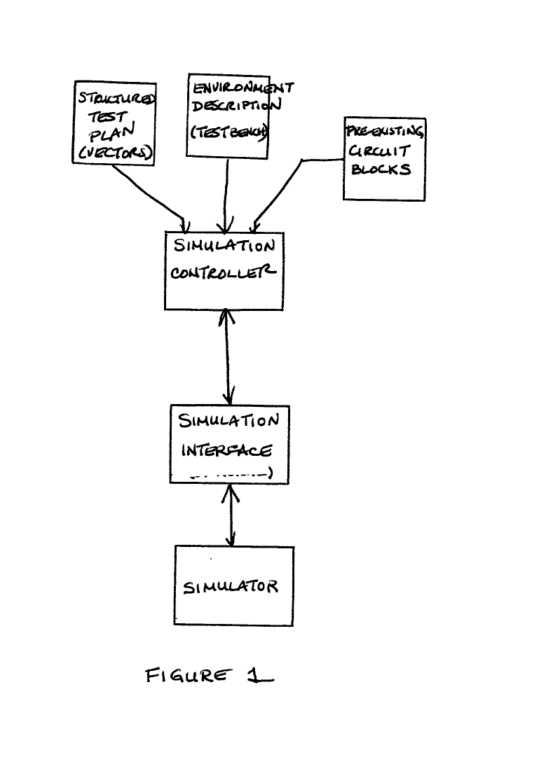

The present invention enables reuse of the design and verification efforts for pre-existing circuit blocks from design to design. As shown in FIG. 1, a simulation controller orchestrates a set of instructions in a computer language to be used on a target simulator. A structured test plan, e.g. vectors, and an environment description are user instructions provided to the simulation controller. In the present embodiment, an optional standalone simulation interface is shown. The simulation interface receives standardized input while generating simulator specific instructions. These features may alternatively be added to the simulation controller or simulator.

A simulation controller includes a global process manager that creates a model manager and a vector manager. The global process manager receives an environment parameter describing the target simulator, a user-defined circuit design e.g. “testbench”, vectors associated with the “testbench”, and list of pre-existing circuit blocks. The model manager generates models when requested by the global process manager. The vector manager generates vectors when requested by the global process manager. The global process manager manages the models and vectors to be received by a target simulator such that a test plan specific to the pre-existing circuit block and environment.

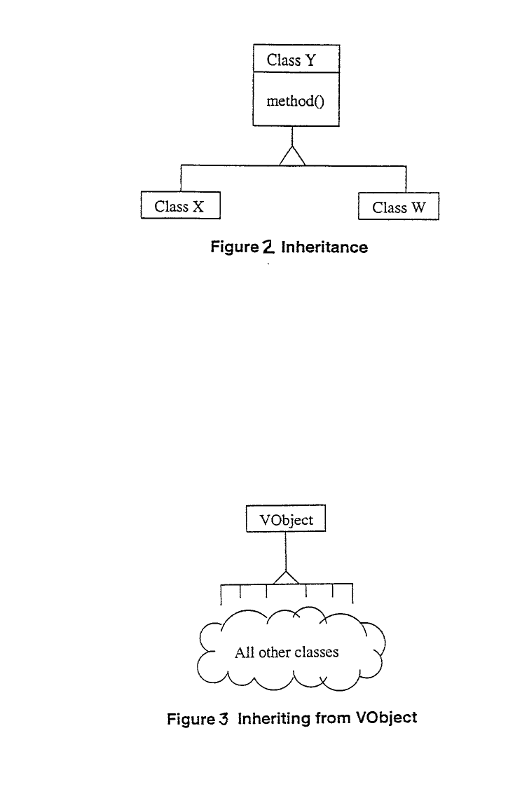

The simulation controller uses the aggregate concept of classes and the concept of inheritance. Each class encapsulates data and methods that act on that data. For inheritance, shown in FIG. 2, class X inherits the properties from class Y and X has access to a subset of class Y's data and methods. If class W also inherits from class Y, class W has access to class Y's data and methods. A base class, VObject, defines the basic characteristics of all classes, as shown in FIG. 3.

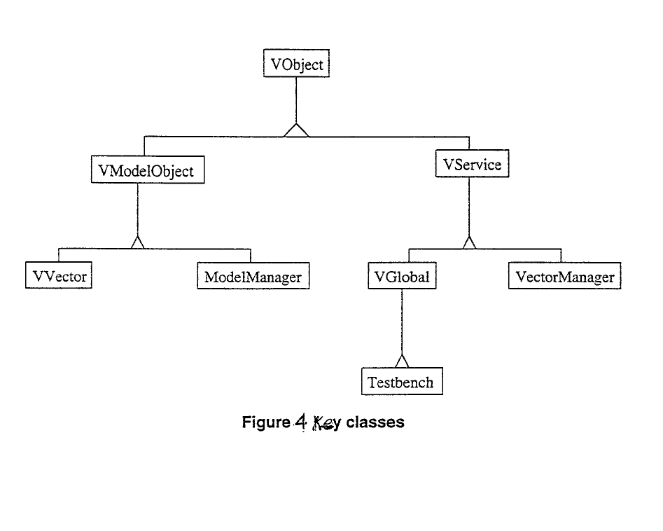

In FIG. 4, the key classes used are VModelObject and its child class VVector. A “V” preceding a class name implies that the class is a virtual class. That is, the class must have one or more child classes that inherit from it. Non-virtual models and vectors are managed by the model object ModelManager and the central service VectorManager, respectively.

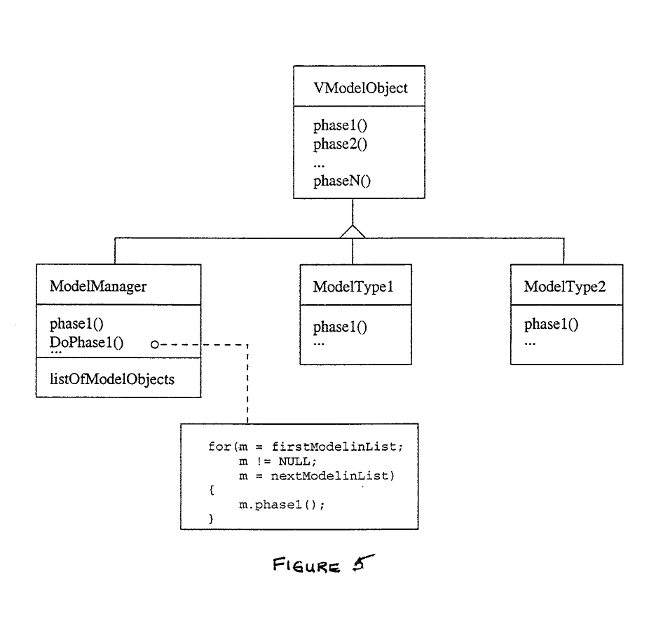

VModelObject contains methods representing the phases that all models go through during simulation. All children of VModelObject, that is, all models and all vectors have the same phase methods that VModelObject has. Thus, the ModelManager can call the phase methods of every model. New types of models can be added to the system without changing the ModelManager, because it knows that all new models will implement each phase. FIG. 5 shows this relationship using class diagram notation.

VVector further refines VModelObject. It takes one of VModelObject's phases and breaks it up into multiple sub-phases that all Vectors go through. The phase that VVector refines is the phase which is allowed to consume simulation time in VModelObject.

VGlobal is a class that aggregates all global objects in the system, e.g. ModelManager and VectorManager. If an object needs to request a service from a global object, the object refers to “global.modelManager.findModel(parameters)”. The user customizes VGlobal for a specific chip by creating a testbench that inherits from VGlobal and refines it.

As shown in FIG. 4, the user defines an instance of VGlobal in the testbench. The global process manager, e.g. VGlobal class, creates the data structures for the VectorManager and the ModelManager. From the test environment description, e.g. testbench, the global process manager creates instances of the customized vectors and model objects to initialize the environment for the pre-existing circuit block to be tested. The models created by the testbench may create other models at a time designated by the ModelManager. From creation onward, the vectors are managed by the VectorManager and the models are managed by the ModelManager. All vectors are automatically models through inheritance, the vectors are further managed by the ModelManager.

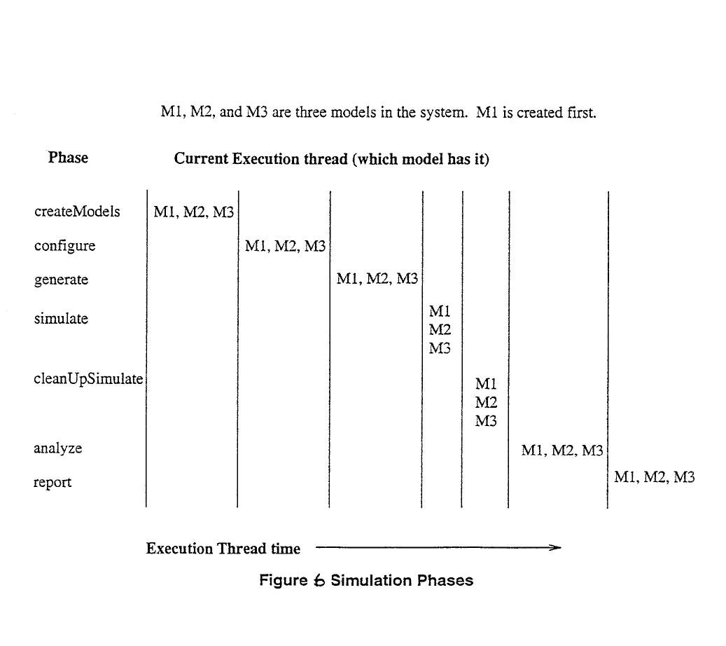

The ModelManager keeps a list of all models. All models have the concept of phase and simulation time. Phase corresponds to the instruction sequence required by the global process manager while simulation time corresponds to when it will be used by the target simulator. All models go through the phases together. No model starts the next phase until all the models have completed the current phase. In most of the phases, the models are processed serially. During the first several initialization phases, each model goes through the phase in order. No model is executed by the target simulator. During the simulate phase, all models enter the simulate phase in parallel. Models may consume simulation time during the simulate phase. This operation is shown in FIG. 6. In this illustrative example the phases are creating or instantiation, configuration, generation, simulation, post-simulation, analysis, and reporting.

The ModelManager ensures that the simulate phase for each model is called in parallel. The execution phases proceed in parallel. One illustration of the instruction sequence is as follows:

task ModelManager:: simulate( )
{

integer semaphore_id, numberofBlockingModels = 0;

Iterator it;
semaphore_id = alloc(SEMAPHORE, 0, 1, 0);
//For each model object in the list
for(it = modelList.front( ); it!=null; it=it.next( ))
{VModelObject vmo;
cast_assign(vmo, it.getData( ));
if (vmo.getUnblockSimulate()==0)
(numberofBlockingModels++:}
fork
{

vmo.simulate( );
if(vmo.getUnblockSimulate( ) == 0)
{semaphore_put(semaphore_id, 1}//Count up blocking
finishes

}join none // Don't wait here. Start everything at time 0

}
//Wait until all forked processes are done.
semaphore_get(WAIT, semaphore_id numberofBlockingModels);

}

There are three concepts shown in the ModelManager instruction sequence. First, the inner most loop consists of a fork/join/none construct because the number of models in the modelList is unknown until run time, the model list must be executed in order. The fork/join/none construct starts all models' simulate ( ) tasks simultaneously. It does not wait for the first one to finish before starting the second one.

The second major concept is the use of semaphores to determine when all forked processes are done. Semaphores are fairly standard and are described in on pages 41-43 and 52-55 of “Modern Operating Systems” by Andrew S. Tanenbaum, Prentice Hall, 1992.

The third concept is that semaphore use is slightly modified by UnblockSimulate. Each model inherently has within it the knowledge of whether it will cause the simulate phase to block, that is, remain in the simulate phase until the model in question is done simulating.

The functionality of semaphores can be easily replaced by an equivalent mathematical construct such as mailboxes or counters.

Vectors contain information that determines the pass/fail criteria for the pre-existing circuit block. During all phases but the simulate( ) phase, the vectors behave like models. The simulate ( ) phase of each vector is broken up into three different sub-phases: initialize( ), execute( ), and cleanUp( ). The VectorManager controls when each vector enters sub-phase. The user may create a sequence file for vectors. The sequence file determines the order in which the vectors will enter the execute( ) sub-phase.

A vector request models that it needs from Testbench. Thus, many vectors may use the same models. The vector is reusable because it does not instantiate any particular model, it merely requests that a model of a given type exist.

While the present embodiment illustrates the VectorManager requesting models, e.g. acting as a central service, this concept can easily be extended to have the ModelManager requesting vectors. In addition, other interactions may be managed by the simulation controller e.g. lists and queues, file input and output, streaming methods, system logging, default models, and configuration of models.

We claim:

1. A simulation controller comprising:
a global process manager;
a model manager created by the global process manager, generating models when requested by the global process manager;
a vector manager created by the global process manager, generating vectors when requested by the global process manager; and
wherein the global process manager manages the models and vectors received by a simulator.

2. A simulation environment, as defined in claim 1, further comprising a simulator, connected to the global process, model, and vector managers, that receives the models and vectors in accordance to instructions provided by the global process manager.

3. A simulation controller, as defined in claim 2, wherein:
the model manager instantiates and configures models upon request of the global process manager; and
these models can direct the creation of new models.

4. A simulation controller, as defined in claim 3, wherein:
the model manager manages the models such that all models are generated and configured sequentially; and
all of the models enter simulation time in parallel.

5. A simulation controller, as defined in claim 1, wherein:
the model manager instantiates and configures models upon request of the global process manager; and
these models may direct the creation of new models.

6. A simulation controller, as defined in claim 5, wherein:
the model manager manages the models such that all models are generated and configured sequentially; and
all of the models enter simulation time in parallel.

7. A simulation control method comprising the steps of:
generating a model manager operative to list the models to be used by a simulator;
generating a vector manager operative to manage the vectors to be used by a simulator;
instantiating a global testbench;
instantiating vectors to be used by the global testbench and simulator;
instantiating the interface models to be simulated with the global testbench; and
configuring the global testbench and interface models to be used by the simulator.

8. A simulation control method, as defined in claim 4, further comprising the step of managing the vectors, the global testbench, and interface models such that the simulator simulates.

9. A simulation control method, as defined in claim 5, further comprising the steps of:
receiving simulation results; and
analyzing the simulation results.
